(19) United States
(12) Patent Application Publication
(10) Pub. No.: US 2016/0125343 A1
(43) Pub. Date: May 5, 2016

(54) System and Method for Providing Secure Remote Access to Computer-Based Work

(71) Applicant: YP-IT LTD., Ottawa (CA)

(72) Inventors: Frank O'Dea, Ottawa (CA); Donald Matthew Rankin Ferguson, Carp (CA); Omar Hussain Choudhry, Ottawa (CA)

(73) Assignee: YP-IT LTD, Ontario (CA)

(21) Appl. No.: 14/889,916

(22) PCT Filed: May 8, 2014
(86) PCT No.: PCT/CA2014/050437

§ 371 Date: Nov. 9, 2015

Related U.S. Application Data
(60) Provisional application No. 61/822,213, filed on May 10, 2013.

(51) Int. Cl. G06Q 10/06; G06Q 40/00; H04L 29/06

(52) U.S. Cl. CPC G06Q 10/06316; H04L 63/0281; G06Q 10/06395; G06Q 40/125

(57) ABSTRACT

Described are various embodiments of a system and method for providing enrolled users secure remote access to computer-based work originating from distinct clients. In some embodiments, the system comprises a network-accessible computing unit having a business application operating thereon and being remotely accessible by distinct network-enabled computing devices via respective secure network connection thereto. The computing unit further has one or more data storage devices operatively associated therewith or accessible thereto to maintain a user register of enrolled users and their respective work capabilities, as well as a register of computer-based tasks to be completed for the distinct clients. The system is operable select at least one of enrolled user as suitable for performing a designated task, authorize the selected user remote access to the business application to complete the designated task; and track work done by the selected user for remuneration purposes.

### FIELD OF THE DISCLOSURE

The present disclosure relates to remote access systems, and in particular, to a system and method for providing secure remote access to computer-based work.

### BACKGROUND

To become a productive member of society, a person must adapt to an environment in which they must become self-sufficient in terms of, for example, knowledge, work skills, life skills, time management skills, and so on. It is also desirable for them to have some remuneration and achieve some savings.

Educational institutions, for example, elementary schools, high schools, colleges and universities provide an opportunity for gaining an incrementally larger knowledge base and a subset of the above skills. Learning institutions have also adopted the public data network, or the Internet, as a method to provide educational services or support students requiring additional assistance in learning certain academic subjects.

Employers typically only recruit individuals with the knowledge, skills and capabilities to complete the necessary work. In some situations, corporations have adopted technology that allows remote access into their own private data network using the Internet to allow qualified employees the ability to work remotely from the office, a concept generally known as telecommuting.

Unemployment rates for youth and disadvantaged individuals are typically higher than those for adults due to one or more of the factors including lack of knowledge, lack of maturity, lack of skills, lack of transport, lack of time availability due to scholastic and extra-curricular activities, mental or physical capacity, and so on. Those in rural areas or whose parents work long hours are exceptionally affected due to a lack of transportation options and thus have few employment opportunities.

Some youth and disadvantaged individuals have part-time jobs which give them limited work experience and some income. Unfortunately, many such jobs are in fast food restaurants or department stores and, while providing some experience and revenue, require commitments of multiple hour periods, limited flexibility in schedule and do not expose them to the diverse occupations available to them when they graduate or provide for development of people skills, leadership, cooperation, teamwork, and so on.

A further consideration is that some jobs in fast food restaurants and stores may involve evening shifts leaving young people to find their way home late at night.

To some extent, a similar problem has been addressed by universities and other institutions of higher learning which have set-up so-called “co-op” programs with private sector companies. Such co-op programs often entail the student spending the summer months of a scholastic semester working in the company and returning to university or other institution for the next semester. While this kind of program might suffice for some students, the majority of individuals are excluded because, for example, their grades are inadequate, there are only a few available positions or they have mental or physical challenges preventing them for competing for the co-op positions.

While prevalent amongst youth and disadvantaged individuals, similar restrictions may also be imposed on or felt by other individuals, such as limited access to appropriately flexible work conditions (e.g. sufficiently flexible time schedules for primary caregivers of children, the severely ill or handicapped, or the elderly), limited access to intellectually challenging work (e.g. sufficiently challenging tasks for educated or capable individuals residing in relatively economically depressed and/or remote geographies), etc.

It would be desirable therefore to provide a system and method for employing youth and disadvantaged individuals which addresses their needs for personal development, remuneration and savings by providing an environment and work which is tailored to their personal skills, maturity level, schedule and transportation challenges, which system may also, or alternatively service other members of society facing similar or related challenges.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for a system and method for providing secure remote access to computer-based work that overcome some of the drawbacks of known techniques, or at least, provide a useful alternative thereto. Some aspects of this disclosure provide examples of such systems.

For instance, in accordance with some aspects, a system and method for providing secure remote access to computer-based work for disadvantaged persons is provided, especially a system and method for providing employment using secure remote access between a computing device of an employee and a computing unit of an employer. These aspects are applicable, in some embodiments, to employment for persons who are disadvantaged because their access to non-local physical workplaces is limited by virtue of their age, the fact that they are mentally, physically or economically challenged, or because they are resident in a region with an inadequate supply of suitable jobs, and so on. Accordingly, these aspects seek to eliminate, or at least mitigate, the impact of one or more of these known development obstacles upon youth and disadvantaged individuals, or at least provide an alternative.

In accordance with one aspect, there is provided a method of providing secure remote access to computer-based work originating from distinct clients, the method comprising: maintaining a user register of enrolled users and their respective work capabilities; maintaining a register of computer-based tasks to be completed for the distinct clients; selecting at least one of said enrolled users as suitable for performing a designated one of said tasks based on said registered capabilities; authorizing said at least one selected user remote access, via a local network-enabled computing device, to a business application operating on a remote network-accessible computing unit, wherein said business application is remotely operable by the at least one selected user over said network to complete said designated task; and tracking work done by said selected user on said designated task for remuneration purposes.

In accordance with another aspect, there is provided a system for providing secure remote access to computer-based work originating from distinct clients, the system comprising: a network-accessible computing unit having a business application operating thereon and being remotely accessible by distinct network-enabled computing devices via respective secure network connection thereto, wherein said computing unit further has one or more data storage devices operatively associated therewith or accessible thereto, and wherein said the computing unit is operable to: maintain, via said one or more data storage devices, a user register of enrolled users and their respective work capabilities, as well as a register of computer-based tasks to be completed for the distinct clients; select at least one of said enrolled users as suitable for performing a designated one of said tasks based on said registered capabilities; authorize said at least one selected user remote access to said business application via a local network-enabled computing device, wherein said business application is remotely operable by the at least one selected user over said network to complete said designated task; and track work done by said selected user on said designated task for remuneration purposes.

According to yet another aspect, there is provided a method of providing secure remote access to computer-based work for disadvantaged persons whose access to non-local physical workplaces is limited by virtue of their age, being mentally, physically or economically challenged, or being in a region with an inadequate supply of suitable jobs, the method comprising the steps of,
under the control of a system operator, using a computing unit comprising processor means having business application software and storage means, and a secure gateway permitting secure access to the computing unit by selected persons from a remote computing device by way of the Internet:
(i) creating a register of persons enrolled as potentially able to perform work for prescribed clients;
(ii) storing a register of capabilities of said persons and a register of client work to be done;
(iii) selecting at least one of said persons as suitable for performing the work being based upon one or more of predetermined criteria including their age group, their being mentally, physically or economically challenged, their being resident in a region with an inadequate supply of suitable jobs, and so on;
(iv) providing the selected person with remote access credentials and an Internet address of the secure gateway, the at least one selected person using the credentials with a computing device to provide a connection between the computing device and the computing unit via the Internet and the secure gateway;
(v) once said connection has been established, the at least one selected person using the computing device to access the business application software on the computing unit to perform said work of the client;
(vi) said computing unit tracking work done by said selected person for remuneration purposes.

According to yet another aspect, there is provided a system for providing secure remote access to computer-based work for disadvantaged persons whose access to non-local physical workplaces is limited by virtue of their age, being mentally, physically or economically challenged, or being in a region with an inadequate supply of suitable jobs, the system comprising:
a computing unit under the control of a system operator, the computing unit comprising processor means having business application software and storage means, and a secure gateway permitting secure access to the computing unit by selected persons from a remote computing device by way of the Internet, the computing unit being operable to:
(i) create a register of persons enrolled as potentially able to perform work for prescribed clients;
(ii) store in said storage means a register of capabilities of said persons and a register of client work to be done;
(iii) select at least one of said persons as suitable for performing the work being based upon one or more of predetermined criteria including their age group, their being mentally, physically or economically challenged, their being resident in a region with an inadequate supply of suitable jobs, and so on;
(iv) provide the selected person with remote access credentials and an Internet address of the secure gateway, the at least one selected person using the credentials with a computing device to provide a connection between the computing device and the computing unit via the Internet and the secure gateway;
(v) once said connection has been established, enable the at least one selected person to use the computing device to access the business application software on the computing unit to perform said work of the client;
(vi) said computing unit tracking work done by said selected person for remuneration purposes.

Embodiments of the above-noted aspects may establish a specialized employment system that enables employment to be made available to youth, disadvantaged individuals and the like of a legally employable age, and may be structured to accommodate educational and personal commitments through flexible work periods and work durations. This specialized employment system may utilize private remote network access based technologies to create a virtual workplace that is accessible from an Internet connected computing device or platform. Given the working office is a virtualized centre that is accessed through standard Internet telecommunication access systems, the access to employable tasks is localized to the computing desktop.

This virtual place of employment may be resident within a specialized computing network environment that is accessed using remote desktop access software systems. In general, all access to this specialized desktop (virtual workplace) may be done using standard Internet access applications on the local computing platform being used by the employee.

Through the implementation of systematic controls, virtual workplace access may be limited to a maximum number of hours through the standard school week that takes into account the age of the employee, legal restrictions on working hours during school days in certain jurisdictions, and, where applicable, the need to maintain proper focus on school. In addition to the limit of work hours, a curfew may be imposed so no employee will be able to conduct work before 6:00 am or past 11:00 pm (local time), for example. This curfew restriction may also be designed to ensure the working day for employees does not significantly encroach on the performance at school or required sleep to lead healthy lives.

In one such embodiment, the systematic controls may be guided by information stored in a register of persons which may include, for example, the person's age, current discipline and level of scholastic study, and jurisdiction of residence to identify any legal or corporate restrictions in place on their work hours as well as guiding selection of persons eligible to perform work based upon funding, policy or criteria for government supportive initiatives. The register of persons may also include, for example, the person's skill levels for reading, writing and speaking languages, knowledge of computer business applications and computer programming languages, and performance ratings from previous projects they have been engaged on that assists in quickly and accurately identifying and assigning a given person to a client work project based upon the specific work project's requirements. These and other such types of user information may, in some embodiments, be jointly and/or independently used to define a user's work capabilities, which capabilities may be independently and/or jointly considered in selecting appropriate tasks to be allocated to such users. For example, a client in the legal community may have work that requires an understanding, specific knowledge and/or skills in the field to ensure that the work is completed efficiently and at a level of professionalism required for the project. These and other such examples will be further described below in accordance with different illustrative embodiments.

In some embodiments, controls of the workday hours are set in place at the entry point of the virtual workplace. Any attempt to enter the virtual workplace during restricted hours will be declined and a system log event will be created and sent to the person involved and their supervisory staff. For example, in some jurisdictions, there are legal restrictions for employers to employ persons under a specific age during school hours on recognized official school days. In one example, persons who are under employment restrictions and whose work activities are in progress approaching the 11:00 pm curfew may be presented with a warning at a fixed time interval. These warnings may be presented at a fixed frequency up until the 11:00 pm mark. At 11:00 pm, their remote desktop system can be placed into a suspended state with the intent of preventing any lost work or file corruption. This suspended state can then remain until their next entry into the virtual workplace, for example the following day during accepted work hours.

Some embodiments may incorporate features to support the personal development of the employed person. These personal development features may include one or more of personal budget management systems, financial management education, career development education, time management education and financial management guidance through experienced leaders. The integrated technical solution may be a complete system that is provided in coordination with third party established financial institutions. The personal financial management assistance and coaching may be fostered and provided through the assigned management primes. Each assigned management prime will be recognized and validated to have credibility and formal awareness of financial management systems. To ensure employees gain financial literacy and personal development skills, an online video or article may be presented to them each month with a set of skill-testing questions provided to each employee. The employed person's return to performing work may be conditional upon correct responses to the skill-testing questions.

Some embodiments may use a parallel savings program that is directly linked to the employee. Within this program, the remuneration package may comprise funds received by the employee for work completed and a contribution of funds directed into an education savings plan. The employee's educational savings are protected, as they are held in trust until the employee is of the age of 18 years old and enrolled in a recognized post-secondary learning institution.

Some embodiments also may provide a method designed to allow youth and disadvantaged individuals to overcome a general concern identified by corporations and other institutions regarding the performance of work tasks. The specialized employment system may include the tailoring of work assignments to the personal development needs, educational skills and capabilities of the employee. Properly structured training and personal development of the skills necessary to complete a particular task provide the opportunity to incrementally assign more advanced work to youth and disadvantaged individuals by building their knowledge and understanding of work tasks traditionally completed by adults and building their self-confidence to be able to complete said tasks.

The net effect of the outlined employment model may provide employment access to youth, disadvantaged and/or similarly challenged individuals in all geographic regions, instill the development of life skills in the area of employment and financial management, provide a referable employment record and accrue savings for post-secondary education/employment opportunities, etc.

Other aspects, features and/or advantages will become more apparent upon reading of the following non-restrictive description of specific embodiments, given by way of example only with reference to the accompanying drawings.

### BRIEF DESCRIPTION OF THE FIGURES

Several embodiments of the present disclosure will be provided, by way of examples only, with reference to the appended drawings, wherein identical or corresponding elements have been given the same or corresponding reference numerals, and wherein:

FIG. 1, labelled EMPLOYEE ACCESS POINTS, illustrates the typical locations where employees would access the System Operator Private Computer Network, via a secure remote desktop server, to gain access to the work environment “Virtual Workplace”, over public Internet connections, in accordance with one embodiment;

FIG. 2, labelled NETWORK TOPOLOGY, illustrates the high-level structure of the Virtual Workplace and its relationship to the employees and supervisory staff, for example remote coaches and team leaders, and to third-party financial institution(s), in accordance with one embodiment;

FIG. 3, labelled EMPLOYEE REGISTRATION PROCESS, illustrates the process to be undertaken and activities required from relevant parties in the selection and registration of a new employee to the System Operator, in accordance with one embodiment;

FIG. 4, labelled EMPLOYEE FINANCIAL SETUP PROCESS, illustrates the process to be undertaken by relevant parties in the verification of, or the creation of, the necessary financial accounts to ensure the employee can receive compensation and education savings plan funds, in accordance with one embodiment;

FIG. 5, labelled VIRTUAL WORKPLACE LOGIN PROCESS, illustrates the process for an employee to access the remote desktop environment and login to the Virtual Workplace, in accordance with one embodiment;

FIG. 6, labelled EMPLOYEE ACCOUNT SETUP PROCESS, illustrates the process to be undertaken by relevant parties to set up user accounts and profiles for individual employees within the Virtual Workplace environment, in accordance with one embodiment;

FIG. 7, labelled WORK ENVIRONMENT LOGIN PROCESS, illustrates the process to be undertaken by relevant parties to verify that an employee is allowed to enter the Virtual Workplace for work purposes, based on the program employment criteria, in accordance with one embodiment;

FIG. 8, labelled WORK RESTRICTIONS REVIEW PROCESS, illustrates the Virtual Workplace access program employment criteria evaluated, in accordance with one embodiment;

FIG. 9, labelled EMPLOYEE TRAINING PROCESS, illustrates the process to be undertaken by relevant parties to provide sufficient and comprehensive training to employees in a Virtual Workplace environment, both upon commencement of work at the System Operator and for individual work tasks, in accordance with one embodiment;

FIG. 10, labelled CLIENT ASSIGNMENT PROCESS, illustrates the process undertaken by the System Operator on how it identifies and designates work received from clients to the appropriate work group, in accordance with one embodiment;

FIG. 11, labelled WORK PREPARATION PROCESS, illustrates the process to be undertaken by relevant parties to prepare sufficient and comprehensive training to employees in a Virtual Workplace environment for individual work tasks, in accordance with one embodiment;

FIG. 12, labelled WORK ASSIGNMENT PROCESS, illustrates the process undertaken by relevant parties to assign work to particular employees and properly train employees to ensure a quality work product, in accordance with one embodiment;

FIG. 13, labelled WORK REVIEW PROCESS, illustrates the process undertaken by relevant parties to review work performed by employees and conduct on-going performance reviews of the employees, in accordance with one embodiment;

FIG. 14, labelled WORK AUDITING PROCESS, illustrates the process undertaken by relevant parties to audit the work performed by employees and managers to ensure a quality work product and reduce fraudulent performance reporting, in accordance with one embodiment; and

FIG. 15, labelled EMPLOYEE LIFE LEARNING PROCESS, illustrates the process undertaken by relevant parties to provide a parental “teaching” experience to the employees to assist them in gaining life lesson knowledge, in accordance with one embodiment.

### DETAILED DESCRIPTION

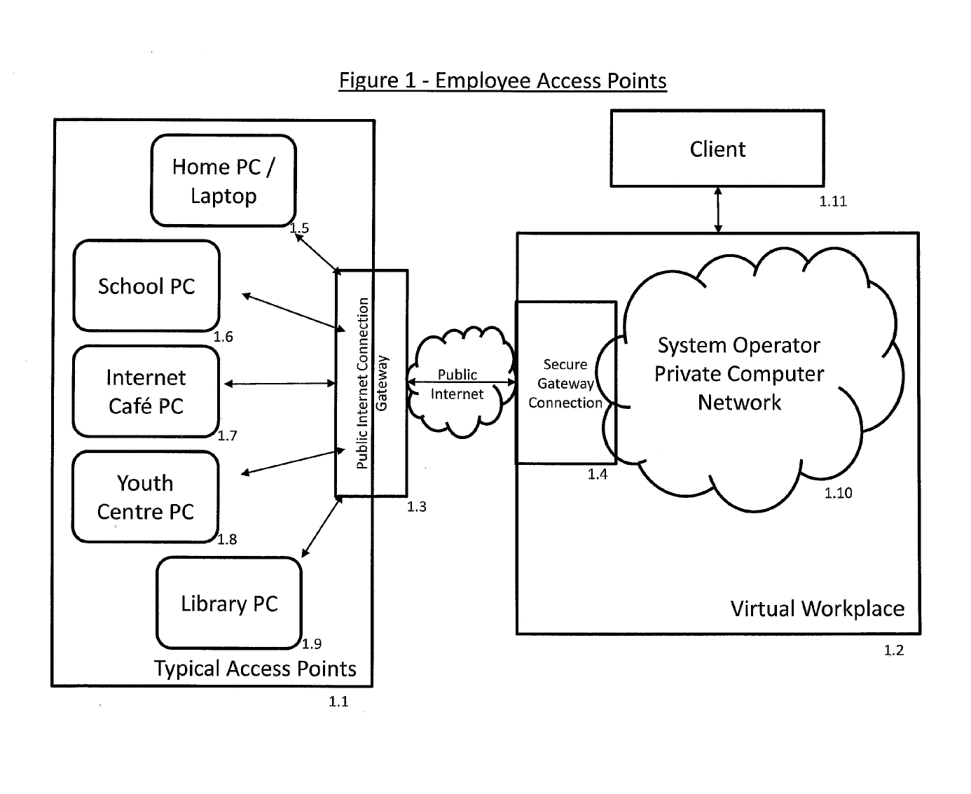

FIG. 1 illustrates a first embodiment in which employees access a private computer network 1.10 in order to perform tasks in a corporate work environment, owned by the System Operator. As shown, the employee may access the private computer network 1.10 via typical access points 1.1, for example, through use of a personal computer or laptop available at home 1.5, or a personal computing device available in public locations such as a school 1.6, Internet caf 1.7, youth centre 1.8 or library 1.9. Other personal or public computing devices, such as tablets, smartphones and/or other network-enabled user terminals may also be considered, as will be appreciated by the skilled artisan. The employee will be able to use the available public Internet connection gateway 1.3 from any of these locations to access the private computer network and the corporate work environment which, conveniently may be referred to as a Virtual Workplace 1.2. By means of a standards-compliant and approved Internet web browser on their personal computing device 1.5 . . . 1.9, the Internet-browser interface will receive input from the employee of a provided website uniform resource locator (URL) address. The Internet-browser interface will enable a connection between the personal computing device and a secure gateway connection 1.4, and will be the interface which displays the remote desktop work environment. The secure gateway connection 1.4 will act as the gateway and control mechanism to restrict access into the System Operator's private computer network 1.10 to authorized users who enter a valid user name and password in the Internet-browser interface.

The System Operator is contacted by clients, for example, via telephone or via email, to request work be conducted. The client 1.11, for example, the work requirements and available data and material necessary to initiate the work tasks, is provided to System Operator authorized staff and is uploaded to the private computer network 1.10 within the Virtual Workplace 1.2. The client data and materials, for example, may be paper documents and may first require to be digitized or may be existing digital material that are then uploaded for access by an employee.

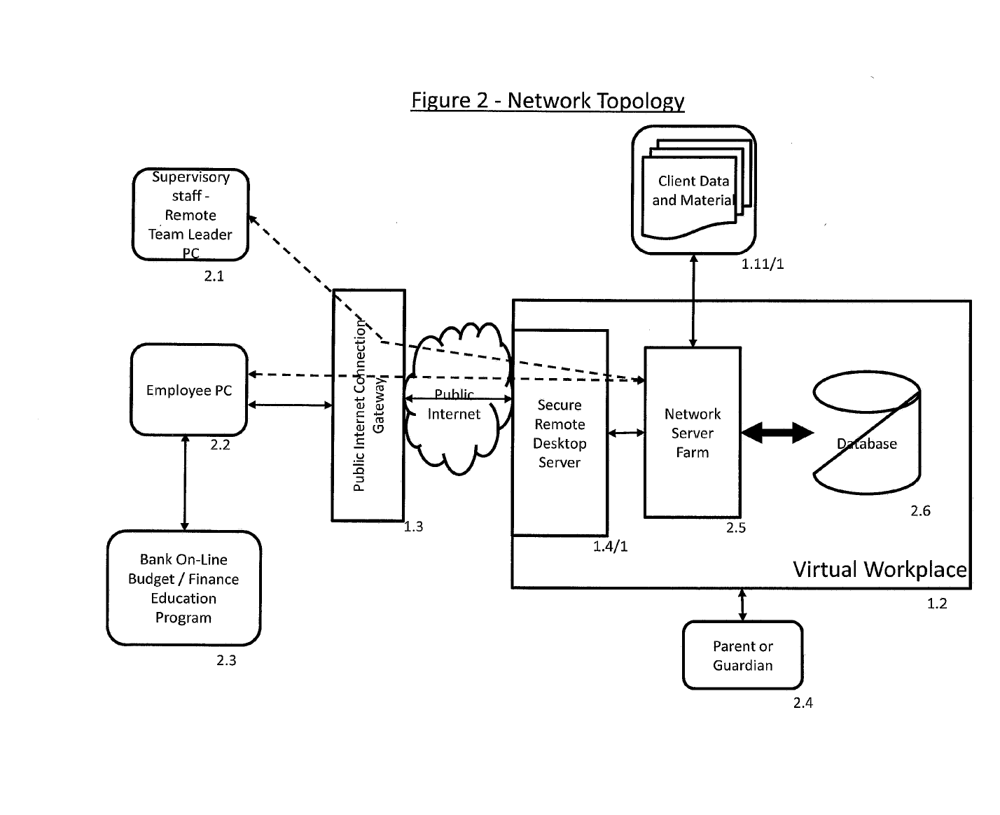

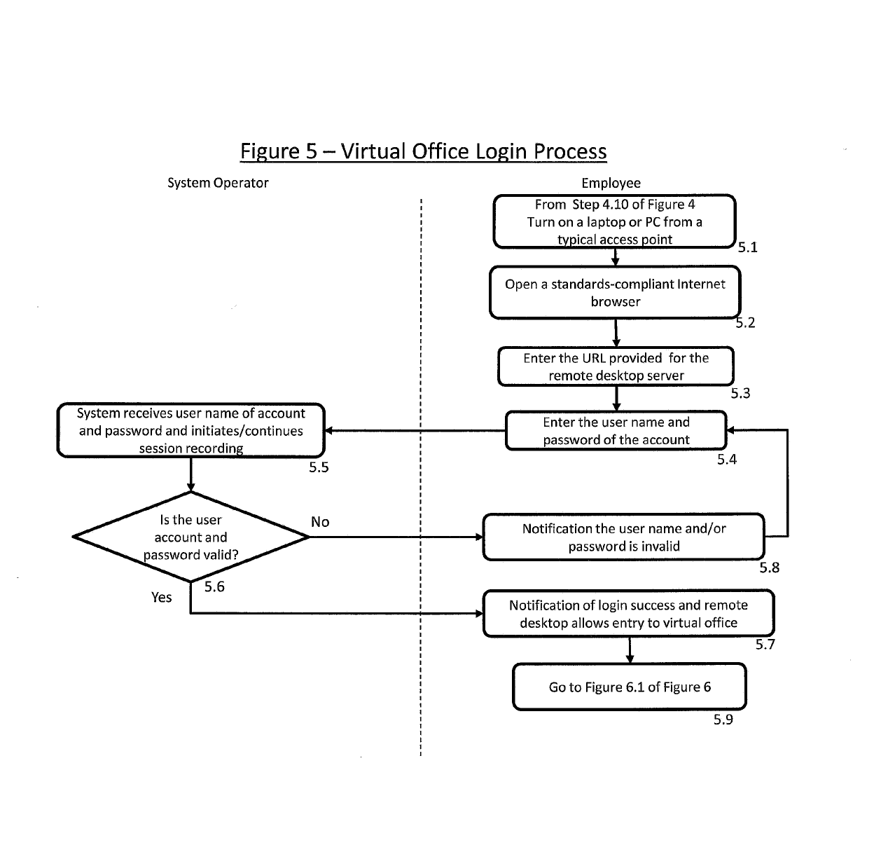

The secure gateway connection 1.4 will provide, for display on the employee's personal computing device, a work environment which is managed by permissions set forth within the Virtual Workplace 1.2 for each employee account and protection from Internet attacks, for example, Denial of Service and viruses. The resulting content displayed on the Internet-browser interface will be controlled by input from the employee via their personal computing device and based upon the Virtual Workplace 1.2 permissions. The interactions between the employee working from a typical access point 1.1 via a personal computing device and the Virtual Workplace 1.2 for accessing the corporate work environment will be common across all typical access points and will be described later with reference to FIG. 5. The Virtual Workplace 1.2 topology, is shown in more detail in FIG. 2.

FIG. 2 is a System Operator private computer network topology for establishing a Virtual Workplace 1.2 and managing employee interactions with it, in accordance with one embodiment. The Virtual Workplace 1.2 contains a gateway 1.4 (FIG. 1) which in this embodiment includes a secure remote desktop server 1.4/1 together with Internet hardware, for example, a modem, a firewall and a router. The configuration and operation of such gateways are well known to people skilled in this art and so will not be described in more detail here. This secure remote desktop server 1.4/1 enables selected ones of the computing devices 1.5 . . . 1.9 to display a desktop environment corresponding to that which would be displayed if the computing device were within the Virtual Workplace 1.2. Suitable such secure remote desktop servers may include, but are not limited to Citrix XenDesktop™ and Microsoft Remote Desktop Services™.

The remote desktop server 1.4/1 exchanges requests made via the Internet-browser interface with the network server farm 2.5 and displays the resulting response to each request on the originating Internet-browser interface. The network server farm 2.5 contains multiple servers for redundancy and load-sharing capabilities, and hosts applications necessary to conduct regular business operations and functionality, for example, user password and access control, manipulation of data, work assignment, training, instructional videos, work product review and auditing, time tracking, payroll administration, instant messaging and email correspondence, etc.

The network server farm 2.5 handles each request received via the remote desktop server 1.4/1 and responds by inserting, modifying or deleting electronic information in the System Operator's database 2.6, as appropriate. The System Operator database 2.6 stores work obtained from the client in the form of, for example, electronic data files and scanned documents 1.11/1, any transcription of or modifications or manipulations made to such material during the processing and handling of the material, as well as employee account information and other data necessary to conduct business.

The Internet-browser interface displays the remote desktop work environment, such that the display is purely a virtual replication of a work environment fully contained within the network and, as a result, restricts all ability to electronically copy, paste or extract content from the remote desktop environment to the personal computing device. Through the secure remote desktop environment, a team leader/coach uses a different personal computing device 2.1 than the employee to access the corporate work environment, and then observes and interacts with employees to provide guidance and support. At all times, interactions and activities conducted through the secure remote desktop server 1.4/1 are recorded and stored within the network server farm 2.5 for review, analysis and verification of activities performed.

As part of the skills development nature of this embodiment, the Internet-browser interface will be used on a personal computing device to provide access to a financial institution's budgeting and financial education program 2.3, as hosted on the financial institution's website. The employee will interact with the Internet-browser interface to view, input and receive information regarding budgeting and financial skills.

The process of inserting the electronic data provided by a client 1.11/1 into the corporate database 2.6 is completed using standard database query language procedures, well known to those skilled in the art.

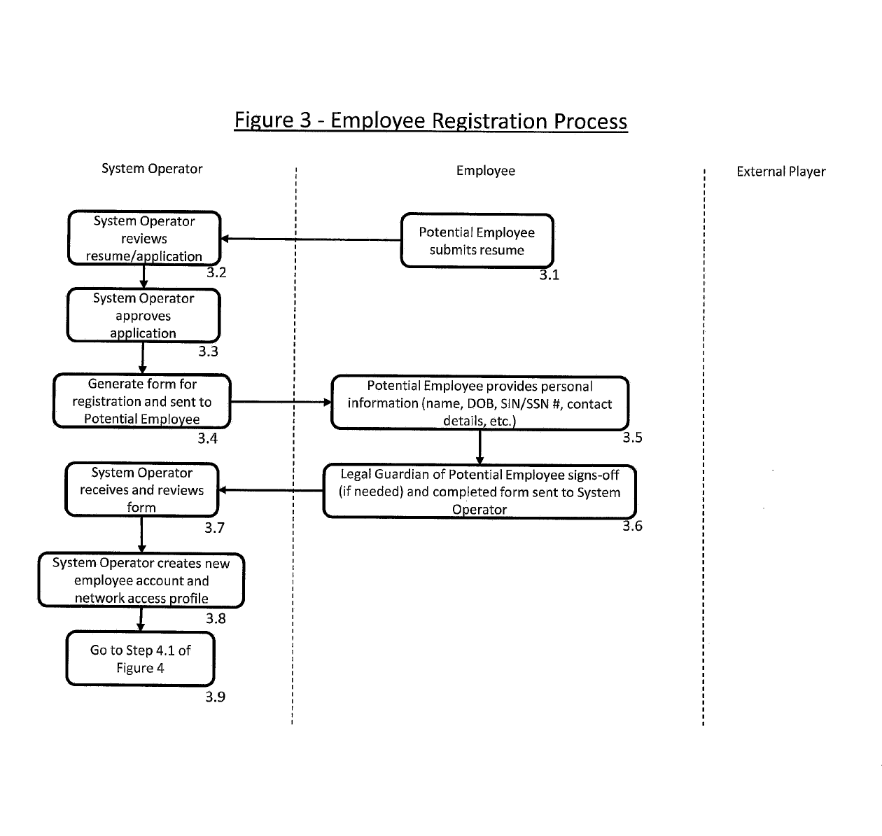

In some embodiments, a parent or guardian 2.4 of a potential employee may contact the System Operator, for example, via telephone or via email, to request work restrictions be implemented for the potential employee, for example, due to poor results at their educational institution. These optional restrictions are defined in the register of persons/employees that is described in FIG. 3.

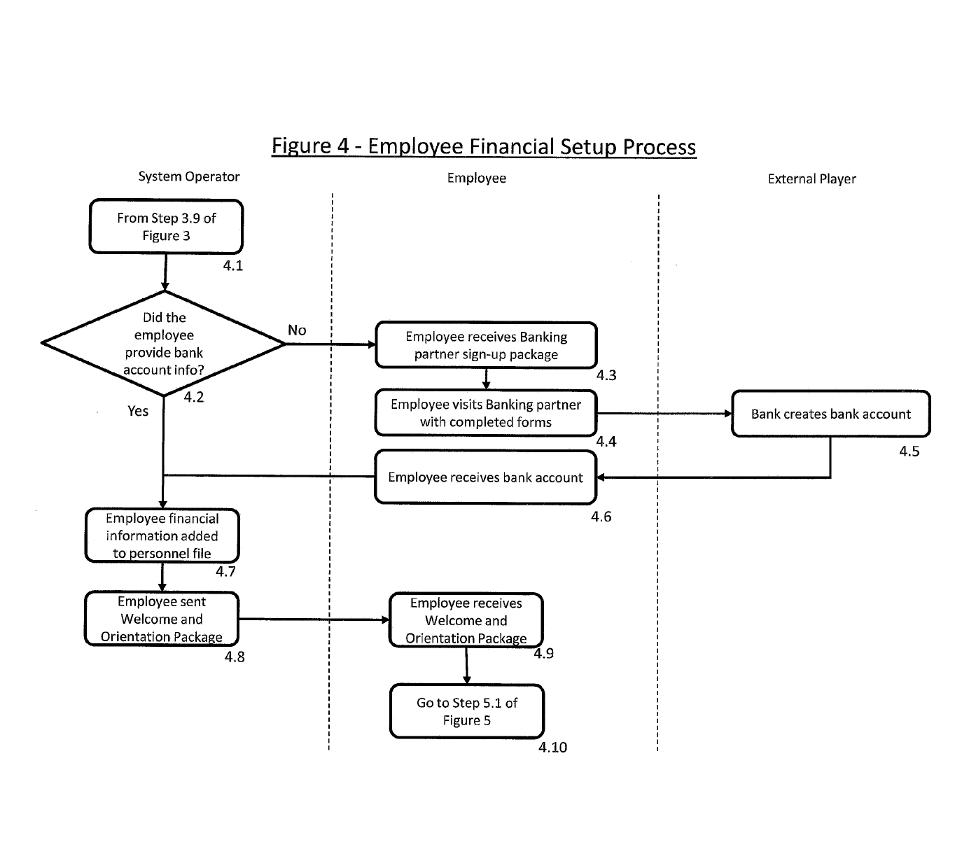

FIG. 3 illustrates the manner in which potential employees express their interest in joining the System Operator by submitting their resume to the System Operator. A potential employee submits at 3.1 a resume along with personal information such as their academic area and level of study, and a preliminary list of skills used to jointly or independently identify the capabilities of each potential employee, such as their ability to speak, read and write in various languages, their computer business application knowledge and skills in computer programming languages, for example. This information may be submitted online through the System Operator website, or again via electronic mail, regular postage-paid mail or other data/document transfer means readily known in the art, for consideration for employment with the System Operator. The System Operator reviews 3.2 applications to ensure that potential employees meet the employee requirements for the position sought. The System Operator approves 3.3 the application if the appropriate qualifications are met. The System Operator generates 3.4 the necessary corporate documentation to register a new employee and sends this documentation, by electronic mail, regular postage-paid mail or other data/document transfer means readily known in the art, to the prospective employee to complete. The potential employee completes 3.5 the forms with the typical employee personal information necessary for any employment, such as a Social Insurance Number or Social Security Number, date of birth, contact and emergency contact information and bank account details for depositing paychecks. Where required by law, a parent or legal guardian for the potential employee would be required to acknowledge the application forms prior to submittal to the System Operator and the potential employee then submits 3.6 the completed forms to the System Operator by electronic mail, regular postage-paid mail or other data/document transfer means readily known in the art. Once received, the System Operator reviews 3.7 the material to ensure that all provided material has been returned. The System Operator creates 3.8 an employee personnel file in the corporate human resources software, register of persons and a corporate network access profile in the remote desktop environment dedicated to the employee, which includes automated import of personal and skill data from the application process described earlier 3.1 and setting access restriction flag criteria used to manage corporate network access and assignment of work processes. The process of setting up the financial accounts for a new employee 3.9 will now be described with reference to FIG. 4.

FIG. 4 illustrates how employee documentation is reviewed to ensure they have provided bank account information prior to the commencement of work for receiving remuneration for work completed, in accordance with one embodiment. The employee registration process 4.1 is that described with reference to FIG. 3. A review of whether the employee has provided a bank account in the registration material is conducted 4.2. If the employee provides no bank account information in the registration material received, the System Operator may provide 4.3 to the employee, by electronic mail, regular postage-paid mail, or the like, a set of pre-packaged materials and contact information of a third-party financial institution where the user may set up a new account, preferably a low or no-fee account. Due to the limited account balances of most employees considered in some embodiments, a no-fee account is clearly preferred to ensure the capacity of a new employee to begin accumulating wealth without excessive monthly fees. The employee receives the banking partner material and, in this example, physically visits 4.4 the financial institution to sign-up for a bank account. A bank account is created 4.5 by the financial institution and the financial institution provides 4.6 the bank account details to the employee. The employee provides 4.7 the System Operator, by electronic mail or by regular postage-paid mail, with the banking information and this information is added to the employee personnel file.

It is envisaged in some embodiments that only a portion of the remuneration might be paid into the above-mentioned bank account, a further portion being paid into an education savings fund available only when the employee is registered in a post-secondary education program. Other shared or distributed remuneration schemes may also be considered depending on the type of users being retained. For example, users having previously expressed or experienced financial hardship or independence may have part of their remuneration automatically directed to a dedicated account set aside, for example, to provide prescribed assistance, services and/or resources. Other examples may also be considered without departing from the general scope and nature of the present disclosure.

As part of the Virtual Workplace 1.2 (FIG. 1), no physical interaction with the new employee is undertaken. As such, a welcome package is sent 4.8 or otherwise made available to the employee by electronic mail, regular postage-paid mail, or other available communication media, which contains corporate information such as an employee handbook that outlines the rules and agreements for working with the System Operator, their employee account profile with temporary password and instructions for accessing the corporate Virtual Workplace 1.2 (FIG. 1), etc. The employee receives 4.9 the welcome package and reviews the material. The process for the employee to login to the Virtual Workplace 1.2 (FIG. 1) using the information provided in the welcome package 4.10 will now be described with reference to FIG. 5.

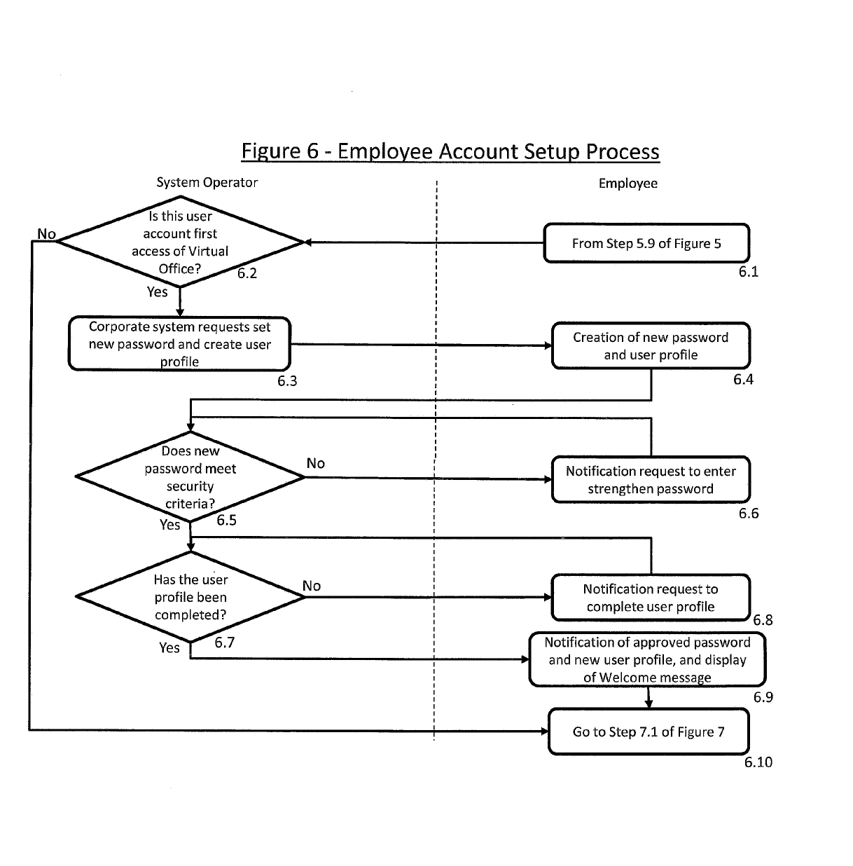

FIG. 5 illustrates how an employee accesses the remote desktop environment and logs into the Virtual Workplace 1.2 (FIG. 1), in accordance with one embodiment. In Step 5.1, an employee turns on a laptop or personal computing device from a typical access point, examples of which are shown in FIG. 1. The employee then opens a standards-compliant and approved Internet web browser 5.2, also referred to as an Internet-browser interface, in which the employee enters 5.3 the web address uniform record locator (URL) that will connect the personal computing device to the secure remote desktop server 1.4/1 (FIG. 2). The Internet-browser interface then displays a window that will require the employee to enter 5.4 a user name and password. The employee submits that information and the remote desktop server 1.4/1 (FIG. 2) receives the submission and initiates session recording 5.5. The remote desktop server 1.4/1 (FIG. 2) verifies that the user name and password provided are valid 5.6 by comparing the submission to the account details stored in the network server farm 2.5 (FIG. 2). If the account information is not valid, the secure remote desktop server 1.4/1 (FIG. 2) sends 5.8 a notification, that is displayed on the Internet-browser interface, indicating that that the information is incorrect and the Internet-browser interface is returned to the unpopulated window for the user to retry entry of a valid user name and password. If they are valid, the remote desktop server 1.4/1 (FIG. 2) sends 5.7 a notification, that is displayed on the Internet-browser interface, indicating that the login was successful and the remote desktop server 1.4/1 (FIG. 2) will present the employee with their remote desktop work environment. The remote desktop server 1.4/1 (FIG. 2) will respond to requests by the employee to display, collect, process and update data as if the employee were sitting at the remote desktop server 1.4/1 (FIG. 2), but with the protection of the employee being unable to copy, print or otherwise extract data to the local personal computer which they are using. Before the employee proceeds to perform tasks, however, the remote desktop server 1.4/1 (FIG. 2) initiates the employee account setup process 5.9 that will now be described with reference to FIG. 6.

FIG. 6 illustrates the process whereby a new employee, with all necessary financial account and employment information having been provided to the System Operator, is allowed to setup their user account, in accordance with one embodiment. Information in the welcome package provides instructions on the process for accessing the Virtual Workplace 1.2 (FIG. 1) using a personalized account name and temporary security password 6.1, which is that described with reference to FIG. 5. The network server farm 2.5 (FIG. 2) identifies 6.2 when an account is used to log in for the first time to the remote desktop environment. If it is the first access, the secure remote desktop server 1.4/1 (FIG. 2) displays 6.3 on the Internet-browser interface of the personal computing device a request to create a new password and create a user profile. The Internet-browser interface of the personal computing device displays a window with fields to allow entry of a new password and confirmation of the password, along with a selection of fields that enable a user profile to be customized by the employee. The Internet-browser interface is used to select 6.4 the desired entries for each field displayed in the window to create the password and user profile. The personal account profile may be designed to allow creativity and demonstrate the individuality of the employee in a manner that makes it interesting and fun for young people, for example.

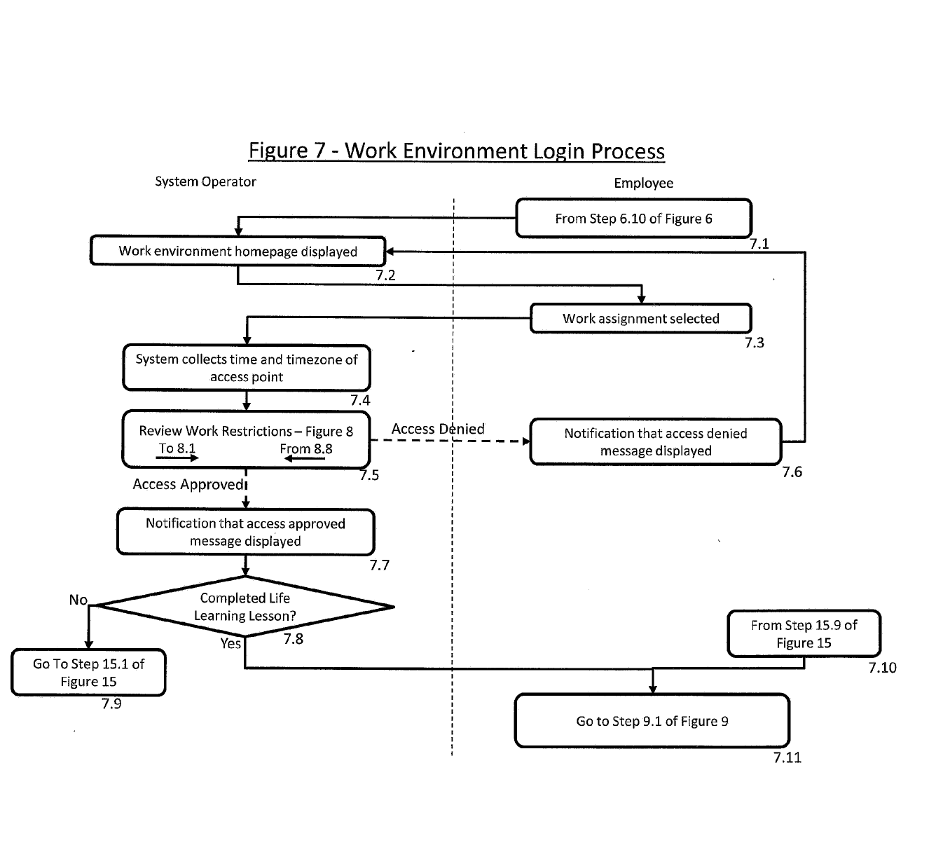

The network server farm 2.5 (FIG. 2) verifies 6.5 that the new password meets the security protocols for password strength required, as set forth in the network server farm 2.5 (FIG. 2). If the password is not strong enough, the Internet-browser interface displays 6.6 a request from the network server farm 2.5 (FIG. 2) to set a stronger password. Once a password of acceptable strength is entered by the employee, the network server farm 2.5 (FIG. 2) verifies 6.7 that the user profile has been completed. If the user profile has not been completed, the Internet-browser interface displays 6.8 a request from the network server farm 2.5 (FIG. 2) to complete the user profile by displaying a notice of an incomplete user profile and the incomplete fields are displayed in a window on the Internet-browser interface. Once both the password is acceptable and the user profile has been completed, the network server farm 2.5 (FIG. 2) sends 6.9 a notification to the Internet-browser interface to display a message that the account update has been approved along with a welcome message. Only then is the employee allowed access to the Virtual Workplace 1.2 (FIG. 1) work environment to perform tasks. The process for an employee to login to the work environment 6.10 will be described with reference to FIG. 7.

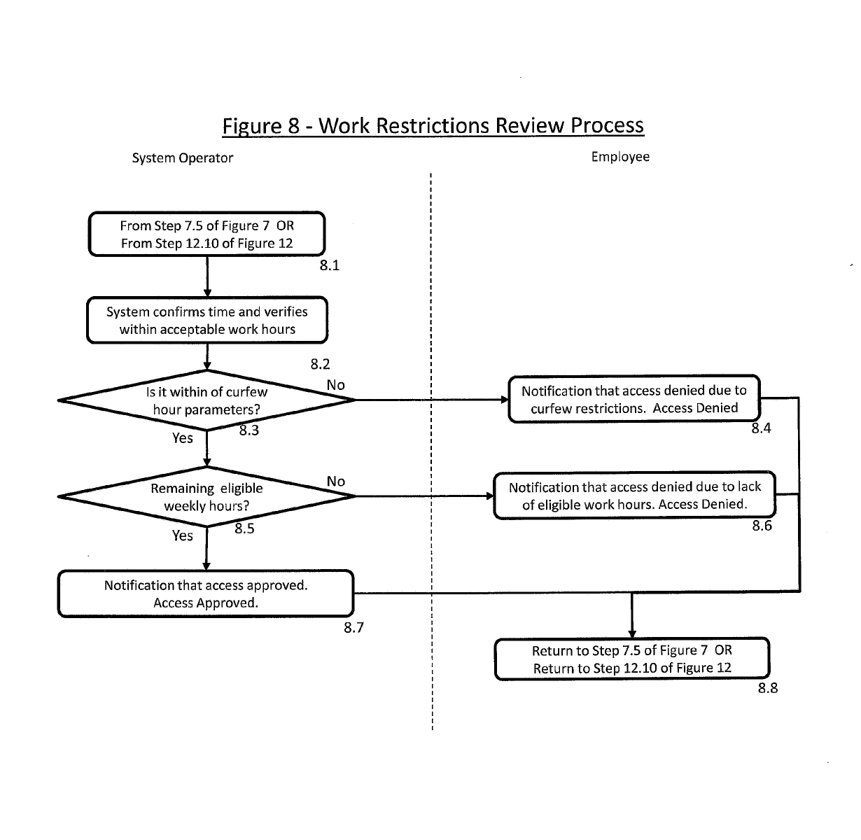

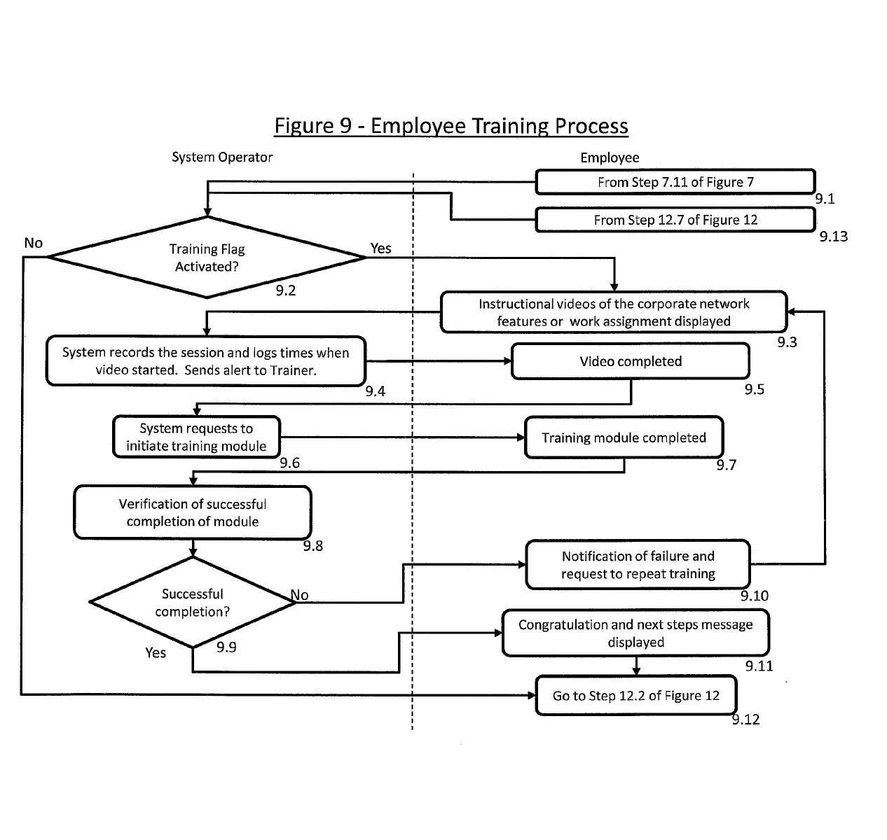

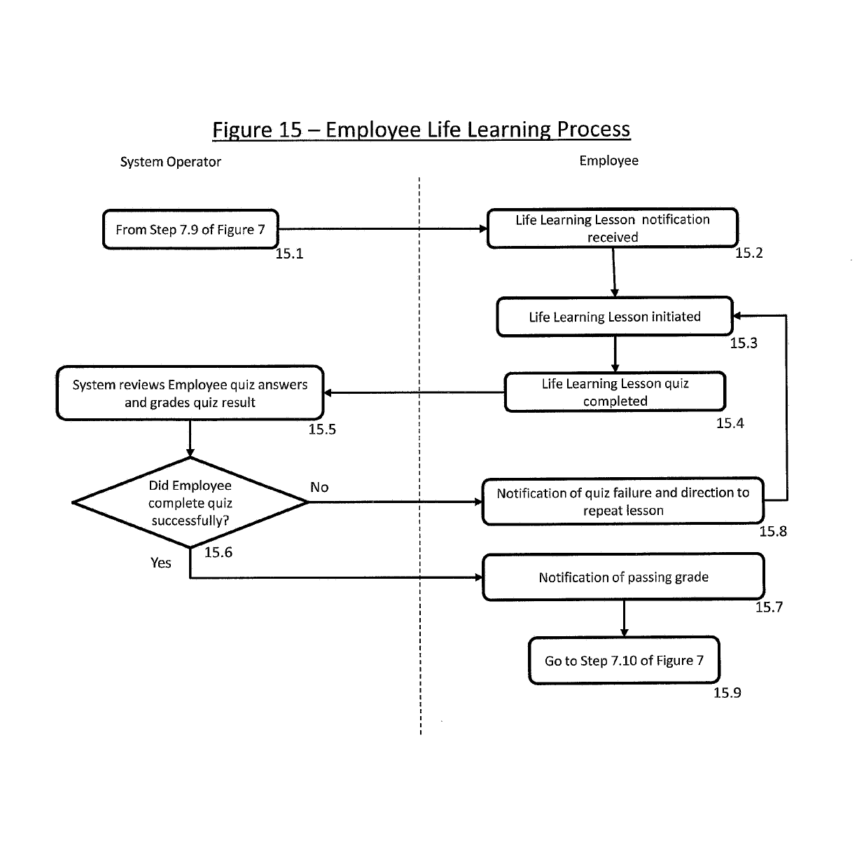

FIG. 7 illustrates how the employee logs into the Virtual Workplace 1.2 (FIG. 1) work environment, in accordance with one embodiment. In Step 7.2, the Internet-browser interface of the personal computing device displays the work environment homepage, which contains a series of links and icons that contain instructional videos, messaging applications and business applications through which work is assigned by the system operator and completed by the employee via the computing device and the Internet. Examples of such business applications software include word processing, spreadsheet, database and image processing software. The Internet-browser interface is used to select a work assignment and submits 7.3 the selection to the network server farm 2.5 (FIG. 2). The network server farm 2.5 (FIG. 2) logs 7.4 the time and time zone of the Internet-browser interface access point (the computing device location) and then compares 7.5 the time and user account settings in the corporate network access profile, which were introduced with reference to FIG. 3, against certain work restrictions, which will be described later with reference to FIG. 8. If the work restrictions are violated 7.6, the Internet-browser interface of the personal computing device displays a notification that states access is denied to initiate work and returns the display of the Internet-browser interface to the work environment homepage 7.2. Conversely, if the work restrictions are not violated 7.7, a notification that access is granted will be displayed. The network server farm 2.5 (FIG. 2) then determines if the user account has been used to complete the periodic life lesson 7.8, which will be described later with reference to FIG. 15. If the life lesson database flag for the account is activated, the Internet-browser interface displays the life lesson window 7.9, which will be described later with reference to FIG. 15. When the life lesson flag has been deactivated, upon completion of the lesson, the Internet-browser interface is returned to the work environment login process 7.10. If the life lesson database flag is not activated, the Internet-browser interface displays the training application window 7.11, which will be described later with reference to FIG. 9.

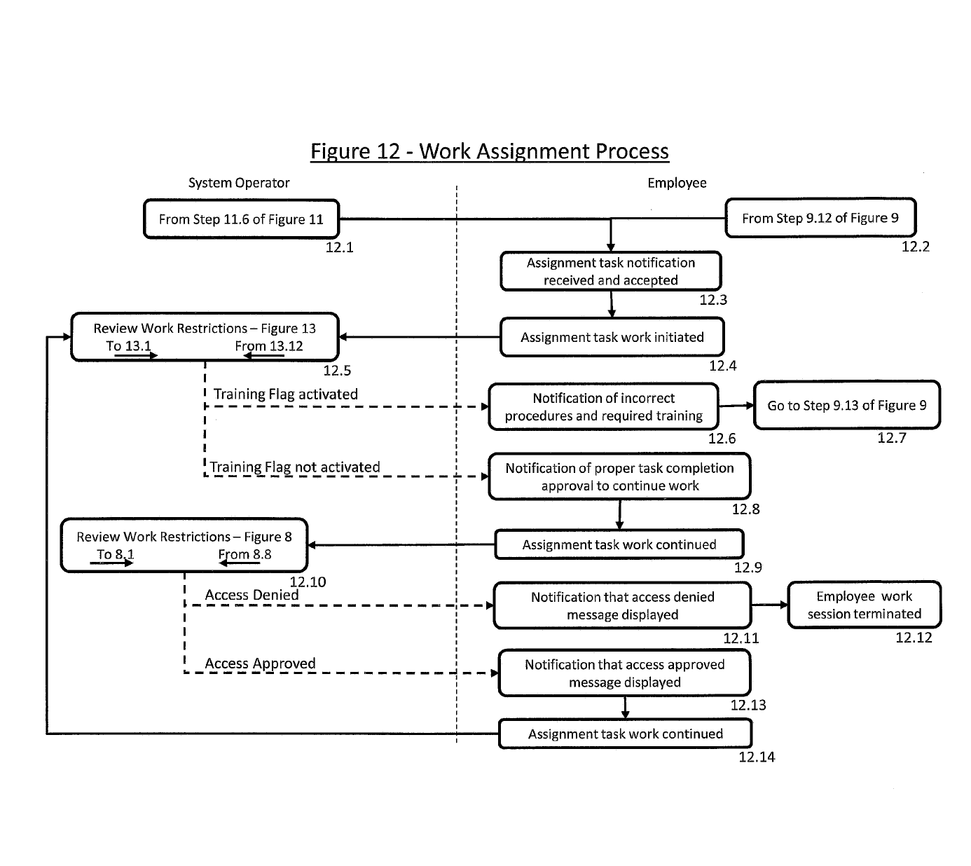

FIG. 8 illustrates how the network server farm 2.5 (FIG. 2) verifies that the current account access meets the work restrictions (e.g., curfew, eligible number of hours per week, allowable shift duration and time of day, and so on) in place for each employee of the System Operator. For example, in some jurisdictions employers are not allowed by law to employ persons of school age during school hours on officially recognized school days. Processes within the Virtual Workplace 1.2 (FIG. 1) which will access this process 8.1, as appropriate, are described with reference to FIG. 7 and later described with reference to FIG. 12. The network server farm 2.5 (FIG. 2), via the secure remote desktop server 1.4/1 (FIG. 2), receives and confirms 8.2 the current time and time zone of the Internet-browser interface on the personal computing device. The network server farm 2.5 (FIG. 2) compares 8.3 the current time, taking into account any time zone differences, with the previously prescribed curfew hour parameters. The network server farm 2.5 (FIG. 2) may send 8.4 a notification that the current time is outside of the previously prescribed curfew hours to the Internet-browser interface that states access to initiate work is denied and return the result to the previous process 8.8, which is described in detail with reference to FIG. 7 and later described with reference to FIG. 12. If, however, curfew restrictions are met, the network server farm 2.5 (FIG. 2) then verifies 8.5 the number of eligible hours remaining on the account. If there are no hours available (e.g., the hours-available field is zero), a notification is sent 8.6 to the Internet-browser interface that states access is denied because there are no hours remaining and returns the result to the previous process 8.8, which is described with reference to FIG. 7 and later described with reference to FIG. 12. If there are hours remaining, a notification is sent 8.7 to the Internet-browser interface that access is granted because no work restrictions are violated and returns the result to the previous process 8.8, which is described with reference to FIG. 7 and later described with reference to FIG. 12.

FIG. 9 illustrates how an employee undergoes a training process which requires self-directed learning consistent with the remote desktop and Virtual Workplace 1.2 (FIG. 1) environment, in accordance with one embodiment. Self-directed learning removes the pressure from the employee to perform at a specific rate and level, but rather at their own pace, to account for differences in each employee's capabilities. The process for an employee to login 9.1 to the work environment with their employee account is as previously described with reference to FIG. 7. The process for an employee to select a work assignment 9.13 will be described later with reference to FIG. 12. In Step 9.2, the network server farm 2.5 (FIG. 2) examines the status of the training flag for the user account, to verify whether the user account has completed the appropriate corporate training programs. If the training flag is not activated, the network server farm 2.5 (FIG. 2) bypasses the training process and redirects the Internet-browser interface of the personal computing device to the available work assignment listing 9.12. If the training flag is activated, the network server farm 2.5 (FIG. 2) causes the Internet-browser interface of the personal computing device to display 9.3 a series of links that contain instructional videos describing the training material to be completed, and includes one or more such topics as the setup of the corporate network, remote desktop and Virtual Workplace 1.2 (FIG. 1) environment accessible on the network server farm 2.5 (FIG. 2), corporate policies, technical training and work assignment tasks 9.3. The Internet-browser interface is used to select each training link and the network server farm 2.5 (FIG. 2) logs 9.4 the session identifiers and times when each video link is selected, sends an email alert to the supervisory staff and records the session. The Internet-browser interface displays the instructional video to completion 9.5. Upon completion of the instructional video, the network server farm 2.5 (FIG. 2) displays 9.6 a request on the Internet-browser interface for the employee to initiate a training module that includes a set of skill-testing questions related to the instructional video topic. The Internet-browser interface displays the training module and enables the employee to select responses to questions transmitted 9.7 from the network server farm 2.5 (FIG. 2). For example, the questions posed to the employee may relate to acceptable corporate behavior, privacy and confidentiality clauses, standard operating procedures and required rules for the handling and processing of client data on a particular project. A grading of the training module is registered in the network server farm 2.5 (FIG. 2) by the supervisory staff via their Internet-browser interface, to determine if the employee has successfully completed the training module 9.8. The network server farm 2.5 (FIG. 2), via the Internet-browser interface displays a message to the employee to repeat training segments where their skill level has not reached sufficient levels 9.9 and the Internet-browser interface returns to display 9.3 the training link. If the employee successfully completes the training program, the Internet-browser interface displays 9.11 a congratulatory notification to the employee and the next steps for beginning current work assignment(s) available to them. The Internet-browser interface redirects the display to available work assignment listing 9.12 which will be described later in FIG. 12.

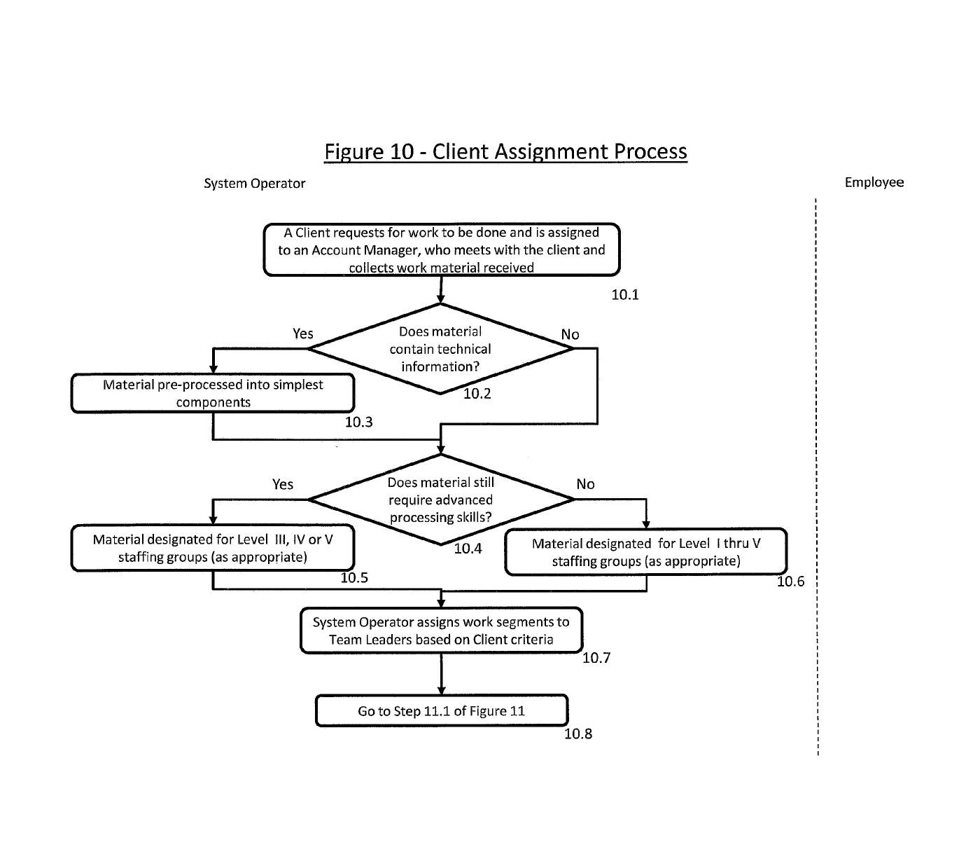

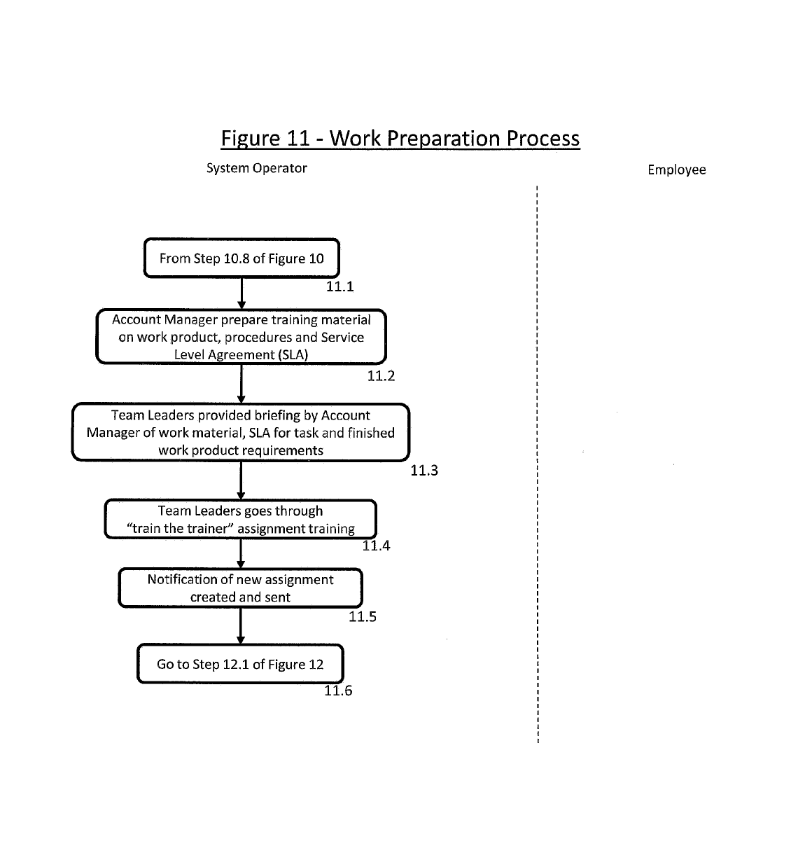

FIG. 10 illustrates how new client assignments are processed to ensure that the work is properly delegated to specific teams of employees based on the level of knowledge and skills necessary, in accordance with one embodiment. A client 1.11 (FIG. 1) contacts 10.1 the System Operator by way of the corporate Internet website, electronic mail or by telephone indicating that they have work which they would like the System Operator to complete, and the corporation assigns the client to an Account Manager. The Account Manager meets with the client to identify the details of the work task and whether there is any technical information in the material to be processed 10.2. If the material includes technical information, work tasks and material are pre-processed 10.3 to breakdown the material to its simplest components possible. The Account Manager determines 10.4 if the material to be processed requires advanced processing skills based on the level of complexity of the work. If the work requires advanced skills, the work is designated 10.5 to a specific group of staff qualified to handle the work task effectively, otherwise, the work is assigned 10.6 to a group of staff based on any additional client criteria. The identification of the specific group of qualified staff is performed by an automated matching of the required skills to perform the work with the skills listed in the register of employees 3.8 that enables the Account Manager to determine an appropriate cohort. Additional client criteria may include, for example, persons who live in a particular jurisdiction, possess a particular level of education or knowledge of a particular discipline or are of a particular demographic such as age or gender, which are other fields contained within the register of employees. The network server farm 2.5 (FIG. 2) sends 10.7 notifications to Team Leaders through the corporate electronic mail system of a new assignment. The process in which new client work, briefing information regarding the project, the task details and the service level agreement are developed and disseminated 10.8 are further described with reference to FIG. 11.

FIG. 11 illustrates how the team leaders use the provided instructions on the needed processing of the data to create specific training information that the employees will be able to review and use to successfully complete the assigned task(s), in accordance with one embodiment. The process for the assignment of client work 11.1, is described with reference to FIG. 10. The Account Manager prepares 11.2 electronic training material, including a video and detailed electronic written instructions, regarding the work task, procedures and the performance requirements and informs Team Leaders via the corporate electronic mail system of the training material. Team Leaders receive 11.3 the notification email and access the electronic training material, including a video and detailed electronic written instructions, regarding the work task, procedures and the performance requirements for review stored on the network server farm 2.5 (FIG. 2). Personal computing devices are used with the Internet-browser interface to access the Virtual Workplace 1.2 (FIG. 1) and, via a web video conferencing system, allows the Account Manager to provide 11.4 a “train the trainer” training session with the Team Leaders to prepare them to properly train and monitor the employees on how to effectively complete their assigned tasks. Notifications are prepared 11.5 for employees indicating a new work assignment is available and sent to employees. The notifications are displayed in the Internet-browser interface of the personal computing devices of an employee when they complete the login process. The process for employees to accept work assignments 11.6 will be described with reference to FIG. 12.

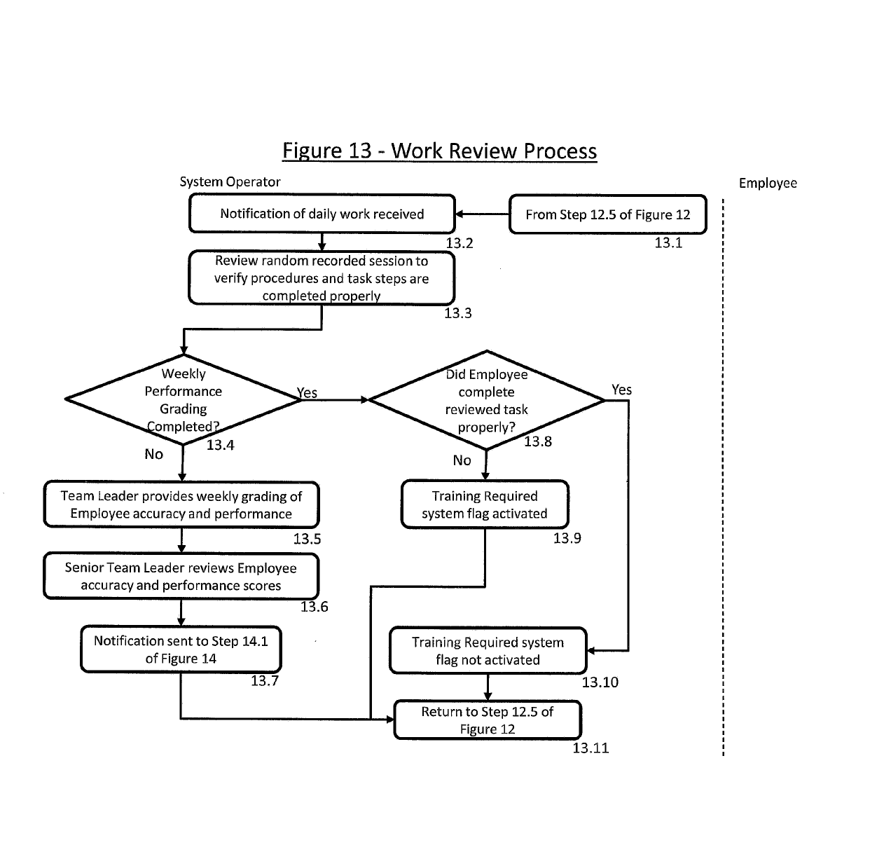

FIG. 12 illustrates the manner in which an employee accepts a work assignment task and conducts the necessary work tasks, while a periodic review of the recorded work performed and work program restrictions are monitored, in accordance with one embodiment. The process in which client work is prepared for employees 12.1 is that described with reference to FIG. 11. After completion of the login process, the Internet-browser interface displays 12.3 a notification of task assignments and the Internet-browser interface is used to submit an acceptance of the assignment to the network server farm 2.5 (FIG. 2). The Internet-browser interface displays the remote desktop work environment, which provides access to initiate 12.4 the task assignment. The Internet-browser interface displays the output from the network server farm 2.5 (FIG. 2) and allows the network server farm 2.5 (FIG. 2) to receive input from the Internet-browser interface of the personal computing device 2.2 (FIG. 2). The process in which the work completed by an employee, via the Internet-browser interface, is reviewed for quality control and quality assurance purposes 12.5 is that described with reference to FIG. 13. For example, the register of persons contains information including the list of skills possessed, details regarding the age and jurisdiction as well as the performance ratings and training completed by each person to control access to the corporate network server. If the review process results in an activation of the Training Flag, a notification of incorrect procedures is displayed 12.6 on the Internet-browser interface of the user account and the Internet-browser interface is redirected 12.7 to the employee training process further described in FIG. 9. For example, if the review identifies that the employee is not following procedures, incorrectly entering content, or so on, the reviewer will activate the training flag for the employee within the register. If the review process results in no activation of the Training Flag a notification of encouragement is displayed 12.8 on the Internet-browser interface of the user account and the Internet-browser interface remains on the work assignment display where the assigned tasks can continue to be completed 12.9. At periodic intervals, the network server farm 2.5 (FIG. 2) triggers the work restrictions process 12.10 which verifies that the user account is adhering to the corporate work environment restrictions, is that described with reference to FIG. 8. If the work restrictions process returns a determination that continued access to the work environment should be denied, a notification is displayed on the Internet-browser interface of personal computing device used by the user account 12.11. The Internet-browser interface is automatically logged out from the virtual network, with the latest modifications automatically saved 12.12. If the work restrictions process returns a determination that continued access to the work environment is approved, a notification with the current access parameters is displayed 12.13 on the Internet-browser interface of personal computing device used by the user account. The Internet-browser interface remains in the work assignment display 12.14 and a trigger of the work review process 12.5 is initiated. The remote desktop server 1.4/1 (FIG. 2) logs the time at which the employee logs out, or a session is terminated, and stops recording of the user session.

FIG. 13 illustrates, in accordance with one embodiment, the manner in which the team leader and the senior team leader periodically reviews the recorded work session of employees to evaluate the employee's performance (e.g., speed, accuracy, etc.,) to ensure that employees are properly completing their assigned task(s) and that the work product generated meets the quality standards of the service level agreement with the client 1.11. The process for receiving information on each employee work assignment session 13.1 is described with reference to FIG. 12. A notification of the number of hours an employee has worked and the number of new entries made into the corporate database 2.6 is displayed 13.2 on the Internet-browser interface of a Team Leader upon login to the Virtual Workplace 1.2 (FIG. 1). This allows the Team Leader to monitor the time spent working and productivity. The Team Leader can review 13.3 randomly selected sessions to verify that the employee is following the instructions provided during training. The network server farm 2.5 (FIG. 2) performs a check 13.4 of each user account to verify that a performance review has been completed. If no check has been performed, a notification is displayed 13.5 on the Internet-browser interface of the associated Team Leader of a missing evaluation and requires the Team Leader to provide a grading. When a new report is submitted to the network server farm 2.5 (FIG. 2) via the Internet-browser interface, a notification is displayed 13.6 on the Internet-browser interface of the associated Senior Team Leader and requires a review and approval of the evaluation. A notification is sent 13.7 to the corporate audit team of a submitted evaluation. If a review has been performed, the network server farm 2.5 (FIG. 2) performs a check 13.8 of each user account to verify the evaluation score of the user account. If the evaluation indicates the user account performed tasks properly, the Training Flag is not activated 13.10. The work review process is terminated and returns to the previous process 13.11, that is described with reference to FIG. 12. Where the employee's performance is determined to be substandard or they are failing to follow the task procedures correctly, the Training Flag is activated 13.9. For example, if the performance criteria for a project is a 98 percent accuracy rate and the review generated a score of only 95 percent, the Training Flag in the register of employees would be activated to enable the employee and Team Leader to be notified of a substandard performance. The work review process is terminated and returns to the previous process 13.11, that is described with reference to FIG. 12.

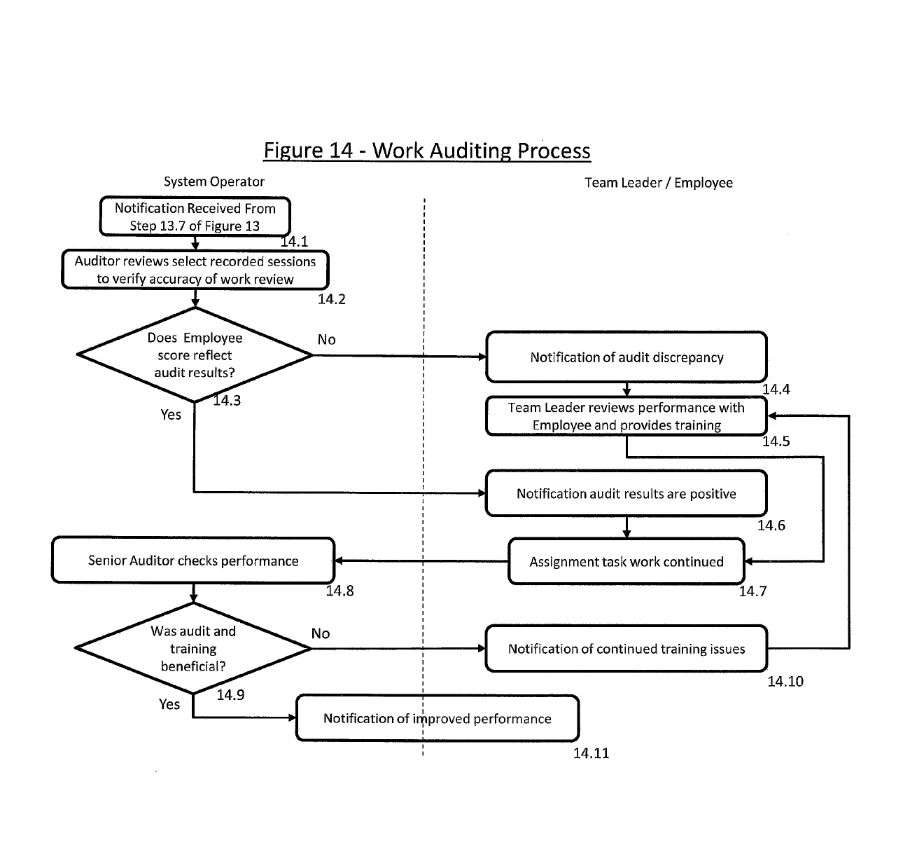

FIG. 14 illustrates, in accordance with one embodiment, a process in which the corporate audit team conducts official audits of the work completed and performance assessments of the team leaders. A notification is received from a Senior Team Leader 14.1 as that described with reference to FIG. 13. An Auditor reviews select recorded sessions of an employee to determine the accuracy and performance of the grading recorded by the Team Leader and records an audit review grade 14.2. A comparison of the Auditor grade to the Team Leader grade is performed 14.3 by the network server farm 2.5 (FIG. 2). If the audit results match the employee evaluation, the Team Leader and Senior Team Leader are notified that audit results are positive 14.6 and the employee is permitted to continue to work 14.7. If the audit results fail to match the employee evaluation, the Team Leader and Senior Team Leader are notified 14.4 of the discrepancy. The Team Leader reviews 14.5 the audit performance with the employee and provides additional training before allowing the employee to continue working 14.7. After the employee restarts working, a Senior Auditor conducts 14.8 a performance audit of the employee's work to verify 14.9 that the audit and training was beneficial in improving the employee's performance. If the secondary audit indicates that performance issues persist, the Team Leader and Senior Team Leader are notified 14.10 about the continued training issues with the employee. If the additional training proved beneficial, the Senior Auditor notifies 14.11 the Team Leader and Senior Team Leader that the employee's performance improved. The multi-level effort regarding quality control and auditing through remote and distinct groups of employees minimizes the potential for collusion or deception. Furthermore, each group of team leaders, supervisors and auditors are randomly rotated amongst the large groups of employees for each task, thereby eliminating any longevity in the chain of command and the ability to organize any potential fraud.

FIG. 15 illustrates, in accordance with on embodiment, how an employee undertakes life learning lessons in the areas of financial management, budgeting, career opportunities, working in the 21st Century workplace and other personal development skills. These life-learning lessons are geared to provide employees with additional skills and knowledge that will help them in their future endeavors. For example, the life learning lessons may include video snippets or articles from select financial institution personnel describing the impact of a poor credit score on the ability of getting a loan and renting an apartment, or the impact of a 28 percent credit card and paying only the monthly minimum balance. The Virtual Workplace 1.2 (FIG. 1) will be configured with life lessons available to an employee to undertake prior to being used by the employee. If the employee has not completed the life lesson required to continue to work 15.1, as described with reference to FIG. 7, a life learning lesson message is displayed 15.2 on the Internet-browser interface based on the criteria of the Life Lesson flag being activated for the employee within the register of employees. The notification contains a link that is selected and redirects the Internet-browser interface to a video or article which must be reviewed 15.3. A set of skill-testing questions are displayed 15.4 on the Internet-browser interface, based on the lesson reviewed, upon completion of the life learning lesson. The network server farm 2.5 (FIG. 2) grades 15.5 the test responses and then compares 15.6 the assigned grade to the required minimum grade. If the employee successfully answers the questions, a notification of the passing grade is displayed 15.7 on the Internet-browser interface and the Internet-browser interface is redirected to the work environment login process 15.9 that described with reference to FIG. 7. If the employee does not successfully answer the questions, a notification is displayed on the Internet-browser interface regarding the failure 15.8 and the Internet-browser interface is redirected 15.3 to repeat the lesson.

While the present disclosure describes various exemplary embodiments, the disclosure is not so limited. To the contrary, the disclosure is intended to cover various modifications and equivalent arrangements included within the general scope of the present disclosure.

1. A method of providing secure remote access to computer-based work originating from distinct clients, the method comprising:
maintaining a user register of enrolled users and their respective work capabilities;
maintaining a register of computer-based tasks to be completed for the distinct clients;
selecting at least one of said enrolled users as suitable for performing a designated one of said tasks based on said registered capabilities; authorizing said at least one selected user remote access, via a local network-enabled computing device, to a business application operating on a remote network-accessible computing unit, wherein said business application is remotely operable by the at least one selected user over said network to complete said designated task; and
tracking work done by said selected user on said designated task for remuneration purposes.

2. A method according to claim 1, further comprising centrally maintaining said network-accessible computing unit and centrally providing access thereto via a secure gateway permitting secure access to said computing unit by said at least one selected user from said local network-enabled computing device via a secure Internet connection.

3. (canceled)

4. A method according to claim 1, wherein said tracking comprises tracking user work session logs via a timer implemented by said computing unit.

5. A method according to claim 1, wherein activity by said selected user while said computing device is connected to said computing unit is recorded by said computing unit.

6. A method according to claim 1, further comprising providing supervisory staff access to said computing unit to audit quality of work completed by each of said enrolled users to identify at least one of: those of said enrolled users in need of further training, those of said enrolled users whose work justifies special reward, and those of said enrolled users whose work justifies a promotion to a more demanding and more remunerative level of work.

7. A method according to claims 1, wherein said tasks are parsed into work segments requiring different capabilities of users selected to perform said different work segments, said computing unit correlating said capabilities of the enrolled users with said different capabilities required to perform a particular work segment and restricting assignment of said particular work segment to selected users whose capabilities would enable those persons to complete said particular work segment.

8. A method according to claim 1, wherein said remuneration includes a direct deposit of a portion of said remuneration into an account in the name of that person at a financial institution, and wherein a further portion of said remuneration is deposited into an education savings fund at a finacial institution, said education savings fund being accessible to the user only when the user is registered in a post-secondary education program.

9. (canceled)

10. A method according to claim 1, wherein said computing unit restricts access of particular enrolled users according to prescribed conditions.

11. (canceled)

12. A method according to claim 10, wherein said conditions include at least one of: a curfew, an eligible number of hours per week, an allowable shift duration and time of day, a jurisdictional law against employing persons of school age during school hours.

13. A method according to claim 1, wherein said computing unit has one or more training modules accessible to selected persons according to specified conditions including at least one of: training related to work assigned to the user, and training related to life skills including at least one of budgeting, financial literacy, time management, business etiquette and/or acumen, career options, personal responsibility and leadership.

14. (canceled)

15. A method according to claim 1, wherein the method provides computer-based work for disadvantaged persons whose access to non-local physical workplaces is limited by virtue of at least one of: their age; being mentally, physically or economically challenged; and being in a region with an inadequate supply of suitable jobs.

16. A system for providing secure remote access to computer-based work originating from distinct clients, the system comprising:
a network-accessible computing unit having a business application operating thereon and being remotely accessible by distinct network-enabled computing devices via respective secure network connection thereto, wherein said computing unit further has one or more data storage devices operatively associated therewith or accessible thereto, and wherein said the computing unit is operable to:
maintain, via said one or more data storage devices, a user register of enrolled users and their respective work capabilities, as well as a register of computer-based tasks to be completed for the distinct clients;
select at least one of said enrolled users as suitable for performing a designated one of said tasks based on said registered capabilities;
authorize said at least one selected user remote access to said business application via a local network-enabled computing device, wherein said business application is remotely operable by the at least one selected user over said network to complete said designated task; and
track work done by said selected user on said designated task for remuneration purposes.

17. A system according to claim 16, wherein said computing unit comprises a centrally maintained computing unit that centrally provides remote access thereto via a secure gateway permitting secure access to said computing unit by said at least one selected user from said local network-enabled computing device via a secure Internet connection.

18. (canceled)

19. A system according to claim 16, wherein said computing unit tracks user work session logs via a timer implemented thereby.

20. A system according to claim 16, wherein activity by said selected user while said computing device is connected to said computing unit is recorded by said computing unit.

21. A system according to claim 16, wherein said computing unit is further accessible by supervisory staff to audit quality of work completed by each of said enrolled users to identify at least one of: those of said enrolled users in need of further training, those of said enrolled users whose work justifies special reward, and those of said enrolled users whose work justifies a promotion to a more demanding and more remunerative level of work.

22. A system according to claim 16, wherein said tasks are parsed into work segments requiring different capabilities of users selected to perform said different work segments, said computing unit operable to correlate said capabilities of the enrolled users with said different capabilities required to perform a particular work segment and restricting assignment of said particular work segment to selected users whose capabilities would enable those persons to complete said particular work segment.

23. A system according to claim 16, wherein said computing unit is further operable to remunerate said enrolled users via a direct deposit of a portion of said remuneration into an account in the name of that user at a financial institution, and wherein said computing unit is further operable deposit a further portion of said remuneration into an education savings fund at a financial institution, said education savings fund being accessible to the user only when the user is registered in a post-secondary education program.

24. (canceled)

25. A system according to claim 16, wherein said computing unit restricts access of particular enrolled users according to prescribed conditions.

26. (canceled)

27. A system according to claim 25, wherein said conditions include at least one of: a curfew, an eligible number of hours per week, an allowable shift duration and time of day, a jurisdictional law against employing persons of school age during school hours.

28. A system according to claims 16, wherein said computing unit has one or more training modules accessible to selected persons according to specified conditions including at least one of: training related to work assigned to the user, and training related to life skills including at least one of budgeting, financial literacy, time management, business etiquette and/or acumen, career options, personal responsibility and leadership.

29. (canceled)

30. (canceled)
